(19) United States
(12) Patent Application Publication
(10) Pub. No.: US 2007/0024950 A1
(43) Pub. Date: Feb. 1, 2007

(54) Electro-optical cell

(75) Inventors: Nynke A.M. Verhaegh, Eindhoven (NL); Dirk K.G. De Boer, DEN BOSCH (NL); Lucas J.M. Schlangen, 'S-Hertogenbosch (NL); Bas Van Der Heijden, Hoogeloon (NL); Mark T. Johnson, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,871

(22) PCT Filed: Jan. 5, 2005
(86) PCT No.: PCT/IB05/50045

§ 371 Date: Jun. 28, 2006

(30) Foreign Application Priority Data
Jan. 8, 2004 (GB) 0400289.5

(51) Int. Cl. G02B 26/00

(52) U.S. Cl. 359/291

(57) ABSTRACT

The invention relates to an electro-optical cell (1) comprising a first (2) and a second (3) support member, an electro-optical medium (5) between the support members and an electrode arrangement (11, 12) on the support members such that an electric field can be applied, in the electro-optical medium, perpendicular to the support members, aligned with the support members or at an oblique angle (7) with respect to the support members. The electro-optical cell further comprises layers (14) of material with different dielectric constant between the support members in order to reduce the inhomogeneity of the electric field lines in the electro-optical medium. By having a layer of cholesteric liquid crystals between the support members, the electro-optical cell will function as a colour filter for varying applied fields. By introducing a particle suspension in a medium between the support members, an electro-optical cell is created that can be switched between a transmissive, reflective and partly deflective state.

The invention relates to an electro-optical cell and more specifically to an arrangement of electrodes to apply electric fields in the cell. The invention has particular but not exclusive application to a controlling operation of a suspended particle device (SPD).

SPDs are used as light shutters and light valves in applications requiring control of light and are switchable between a transmissive and a non transmissive state. They can for example be used in screens for personal computers and mobile telecommunication devices in combination with LCD screens. The SPD can transmit light from a backlight to the LCD screen when the environment of the screen is dark, or, when there is bright light in front of the screen, the SPD can reflect light from the surroundings instead of using the backlight.

Conventional SPDs comprise first and second generally parallel, spaced apart support members, such as glass plates, with a suspended particle medium between them. The suspended particle medium may comprise elongate reflecting particles in a supporting liquid. Electrodes are provided on the support members for applying an electric field to the suspended particles in one or more individual cells. The particles adopt a random orientation in the absence of an applied field. Early SPDs use the random orientation of the suspended particles to provide the non-transmissive state. Incident light is obstructed by the randomly oriented particles and is scattered. The transmissive state is formed by applying an electric field in the direction of the light, making the particles align with their long axis parallel to the direction of the incident light, reducing the scattering considerably. However, the switching from the aligned state to the random state is slow since the time it takes to switch depends on thermal relaxation forces.

The switching times have been improved by creating a non-transmissive state in which the particles are caused to align with an electric field perpendicular to the direction of the incident light. However, this requires additional electrodes, on more than two sides of the suspended particle medium.

Furthermore, there are no electro-optical cells in the prior art that are able to realise a homogeneous electric field diagonal to the support members of the cell.

Moreover, particles subject to only one electric field still have one degree of freedom, which may cause undesired scattering.

The invention seeks to provide an electrode arrangement on the first and second support members of an electro-optical cell to realise electric fields perpendicular to the support members, parallel to the support members and at a diagonal angle to the support members.

The invention also seeks to utilise the electric fields realised by the electrode arrangement to be able to switch between a transmissive, a reflective and a partly deflective state.

The invention further seeks to utilise the electrode arrangement in order to realise two perpendicular fields in the cell to reduce the degrees of freedom of the suspended particles.

According to the invention there is provided an electro-optical cell comprising: first and second support members at least one of which is transparent to optical radiation passing through the cell; an electro-optical medium between the support members; and an electrode arrangement on both first and second support member to apply an electric field to the electro-optical medium, wherein the direction of the applied field can be changed from at least a first non-zero field distribution to at least a second non-zero field distribution, different from the first field distribution, by modifying the voltages of the electrodes, and wherein the direction of the first field distribution is other than opposite to that of the second field distribution.

The electro-optical cell may be filled with suspended particles in a medium or cholesteric liquid crystals.

Thus, an advantage of the invention is that it provides means for aligning at least a proportion of the particles in a configuration that allows the cell to be switched into a transmissive mode, a reflective mode or a partly deflective mode.

The invention further provides means for reducing the inhomogeneity of the electric field distribution in the electro-optical cell comprising using more than one layer of dielectric material between the electrodes where said layers consist of materials of different dielectric constants.

Yet further, the invention provides means for reducing the degrees of freedom of the particles in the particle suspension by applying an electric field distribution that is perpendicular to the first or second field distribution. When both fields are applied intermittently, the degree of freedom in the particle orientation is eliminated.

Embodiments of the invention will now be described by way of example with reference to the accompanying drawings, in which:

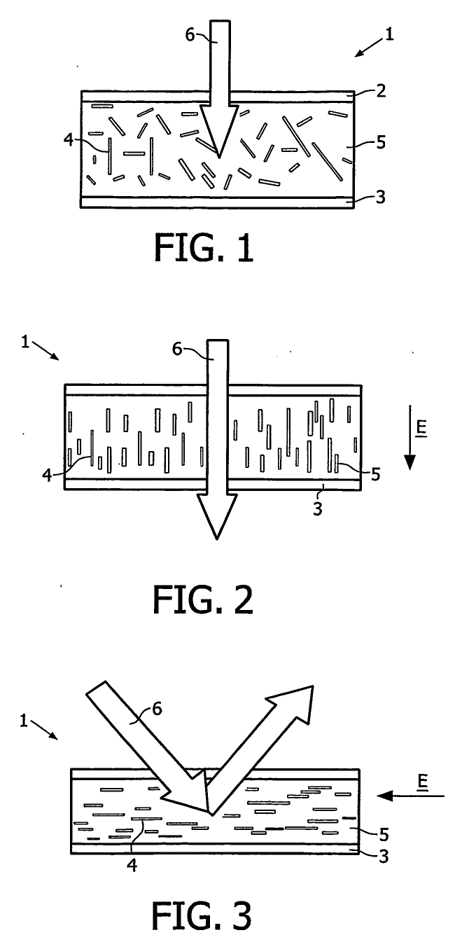

FIG. 1 depicts an electro-optical cell containing suspended particles in a random state;

FIG. 2 depicts an electro-optical cell containing suspended particles subject to an electric field perpendicular to the support members;

FIG. 3 depicts an electro-optical cell containing suspended particles subject to an electric field parallel to the support members;

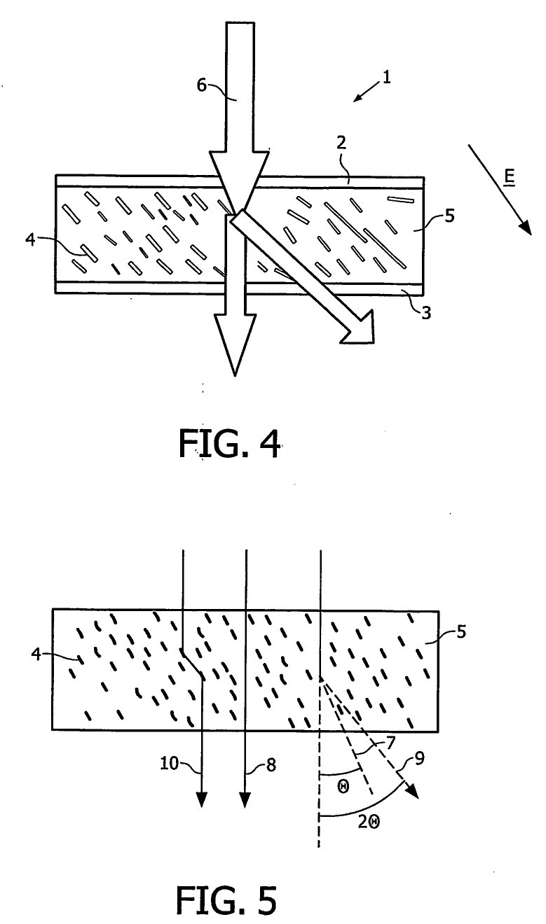

FIG. 4 depicts an electro-optical cell containing suspended particles subject to an electric field at an angle to the support members;

FIG. 5 illustrates how light going through the electro-optical cell in FIG. 4 will be deflected;

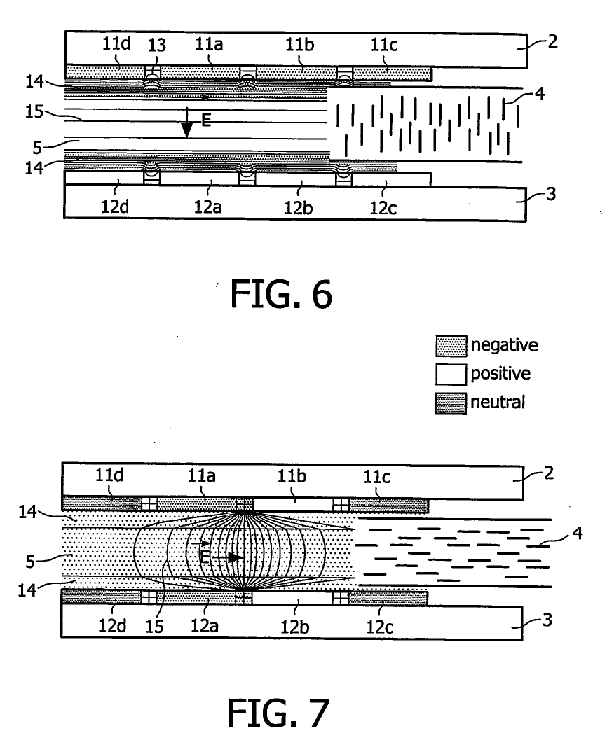

FIG. 6 shows an electro-optical cell with electrodes used for realising an electric field perpendicular to the support members;

FIG. 7 shows an electro-optical cell with electrodes used for realising an electric field parallel to the support members;

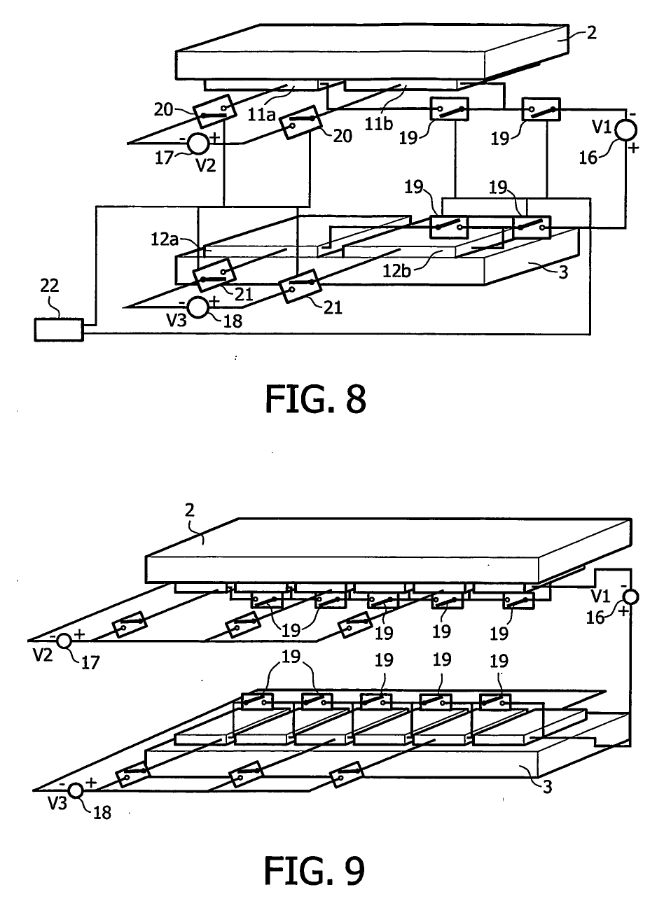

FIG. 8 illustrates one way of connecting the electrodes to realise the electric fields of FIG. 6 and FIG. 7;

FIG. 9 illustrates one way of connecting a row of electro-optical unit cells to realise the electric fields of FIG. 6 and FIG. 7 across the complete row;

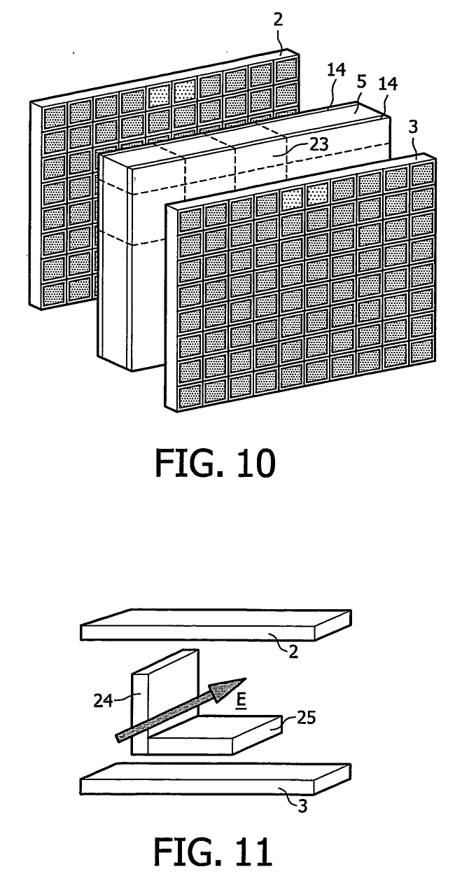

FIG. 10 shows the layers of electrodes and particle suspension that would make up part of a display;

FIG. 11 illustrates how a particle in suspension has more than one degree of freedom;

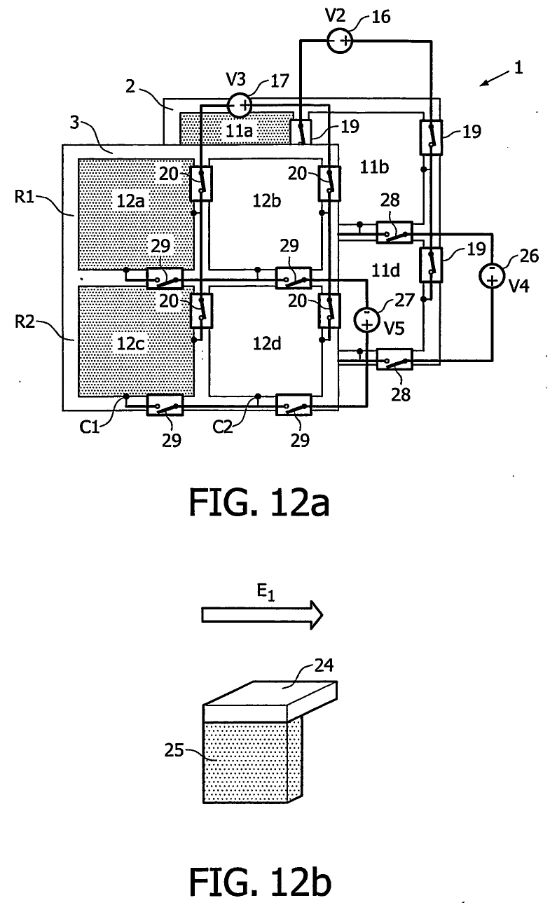

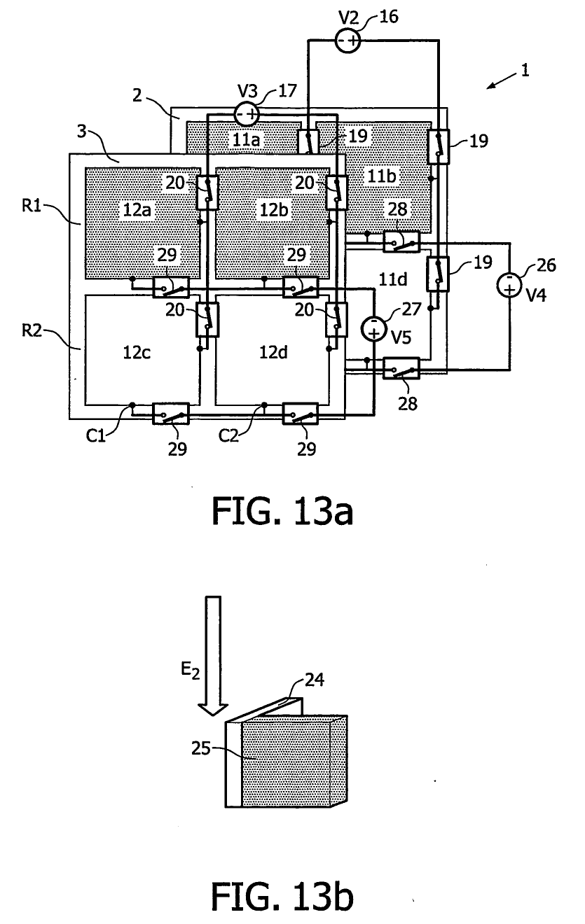

FIGS. 12(a)-(b) and FIG. 13(a)-(b) depict an electro-optical unit cell with an electrode arrangement for realising a highly reflective state, in which the suspended particles only have one degree of freedom;

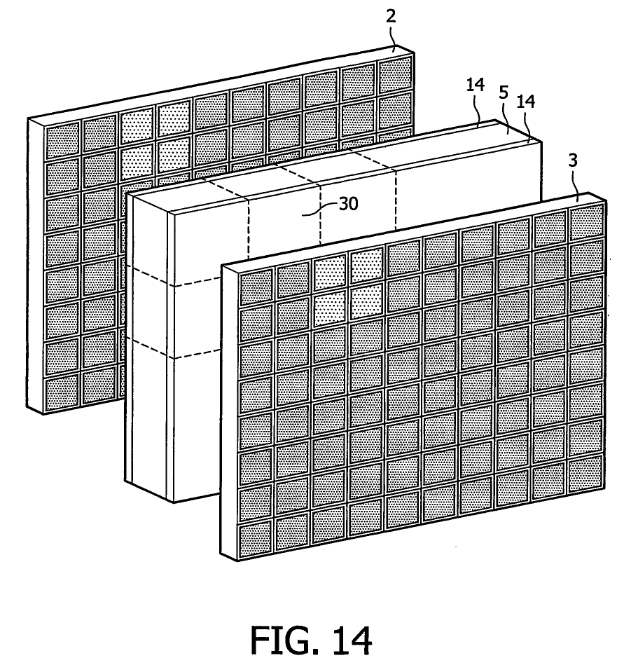

FIG. 14 shows how the electro-optical unit cell of FIG. 12 and FIG. 13 is arranged in respect to layers of electrodes and particle suspension that would make up part of a display;

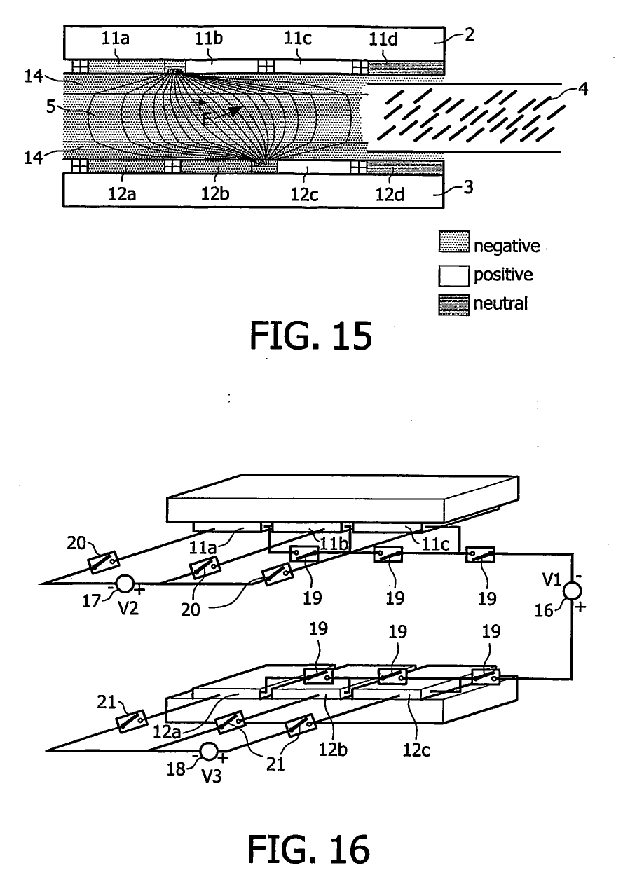

FIG. 15 shows an electro-optical cell with electrodes used for realising an electric field at an angle to the support members;

FIG. 16 illustrates one way of connecting the electrodes to realise the electric fields of FIG. 15;

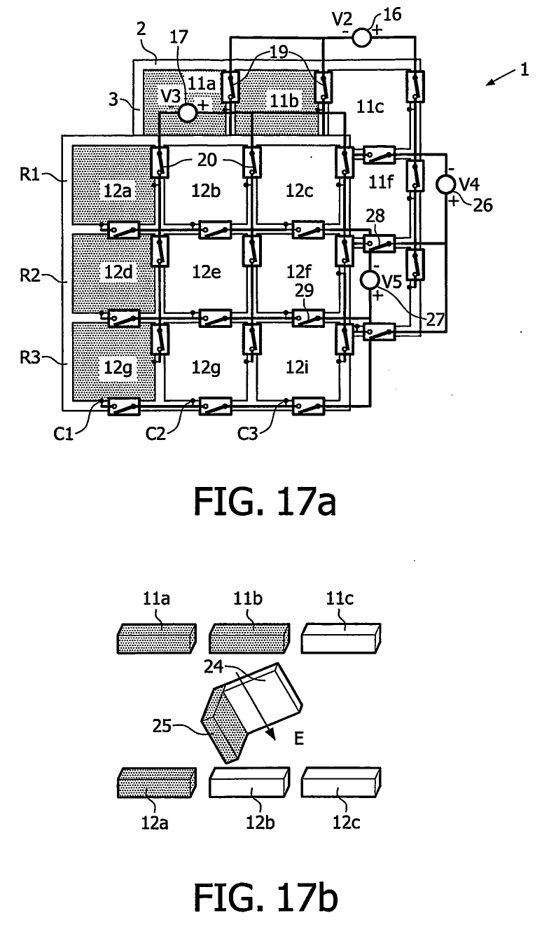

FIGS. 17(a)-(b) and 18(a)-(b) depict an electro-optical unit cell switchable between a transmissive state, a highly reflective state and a deflective state, in which the particles only have one degree of freedom;

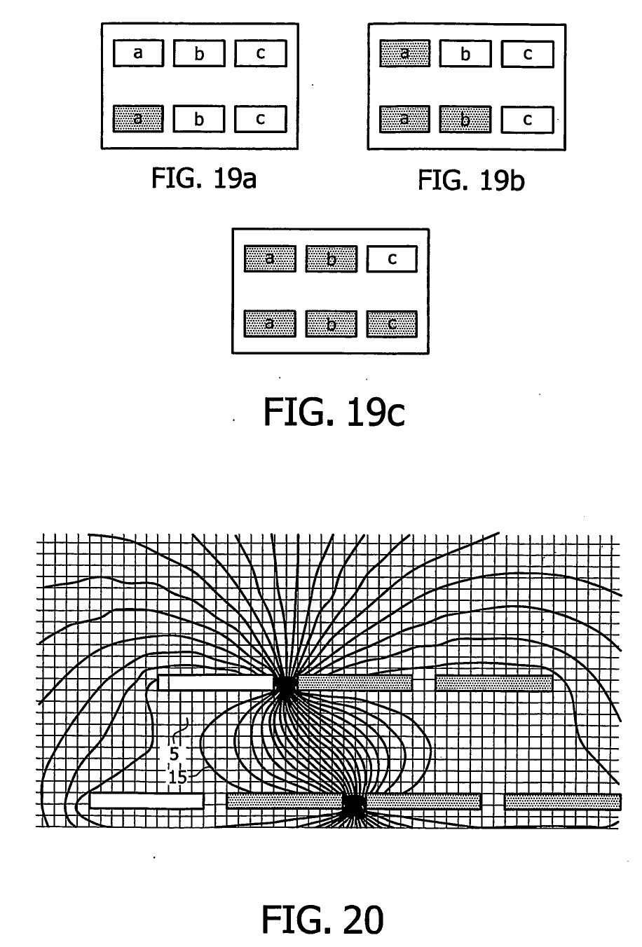

FIGS. 19(a)-(c) illustrate a method on how to realise a strong homogeneous deflective orientation of the suspended particles throughout the whole unit cell;

FIG. 20 illustrates the effect of the passivation layers;

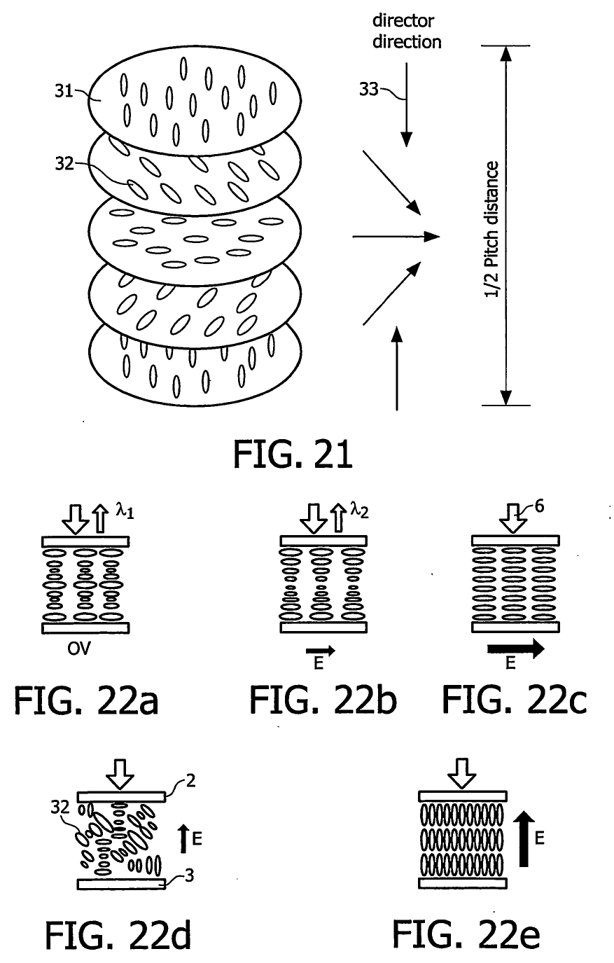

FIG. 21 illustrates schematically the helix structure of cholesteric liquid crystal layers; and

FIGS. 22(a)-(e) illustrate the orientation of the cholesteric liquid crystals for various applied electric fields.

FIG. 1 shows an electro-optical suspended particle cell 1 with no electric field applied. The cell comprises two support members 2 and 3 with suspended particles 4 in a medium 5 between them. The suspended particles are anisometric, i.e. they have unsymmetrical features. Typically they are elongated platelets with unequal height, width and depth. The particles are aligned at random. The support members are transparent and allow light 6 to pass through the cell. The light 6 will scatter off the randomly aligned particles 4. Accordingly, the cell does not transmit light well.

FIG. 2 shows the electro-optical cell with an electric field applied perpendicular to the support members 2 and 3. The particles 4 align with their long axis parallel to the direction of the applied field resulting in that the light 6 can pass through the cell without being significantly scattered. Consequently, the cell is in a transmissive mode.

FIG. 3 shows the electro-optical cell when an electric field is applied parallel to the support members 2 and 3. The suspended particles consequently align with their long axis parallel to the field direction and perpendicular to the light 6. The cell may contain reflective particles that will reflect the light as it scatters off the particles and consequently the cell does not transmit the light. The non-transmissive configuration shown in FIG. 3 is preferable to the configuration shown in FIG. 1 when considering switching times. The switching time to obtain the orientation in FIG. 1 from a highly aligned state depends on the thermal relaxation of the particles while the switching time to the orientation in FIG. 3 depends on the electrical forces. The latter is much faster than the first in case of large particle size.

FIG. 4 shows the electro-optical cell when a diagonal electric field is applied. The particles 4 align themselves at an angle 7 with respect to the normal of the support members 2,3 and consequently a portion of the light passing through the cell will be deflected. FIG. 4 shows three beams 8, 9, 10 entering the cell. A small portion 8 of the light will go straight through the cell without being scattered off any particles. Another portion of the light 9 will scatter off an odd number of particles and be deflected at an angle twice the size of the angle 7 the particle makes with the normal of the support members. Moreover, a third portion 10 of the light will be scattered off an even number of particles, and the final direction of the light is parallel to the incident beam.

In accordance with the invention the particle orientations of FIG. 2 to FIG. 4 can be achieved with electrodes solely on the first and second support member.

FIG. 6 shows an array of electrodes 11 and 12 on the support members 2 and 3 respectively. The electrodes 11 on support member 2 are aligned oppositely to the electrodes 12 on support member 3. Furthermore, the electrodes are separated by a gap 13 to allow insulation between the electrodes. The support members 2, 3 are typically made out of an insulating transparent material like glass, quartz, plastic or silicon oxide (SiO₂). The electrodes 11,12 are typically formed using a conductive material like indium tin oxide (ITO) deposited in a CVD or sputtering process. To achieve an electric field perpendicular to the support members 2,3, the top electrodes 11 are made negative and the bottom electrodes 12 are made positive. The different shades of the electrodes in FIG. 6 indicate the different voltages. White corresponds to positively charged, grey corresponds to negatively charged and black corresponds to neutral. The space between the support members includes a middle layer comprising the suspension medium 5 and two outer passivation layers 14, wherein the suspension medium 5 has a high dielectric constant and the passivation layers 14 have a lower dielectric constant. The purpose of the passivation layer 14 is to reduce the homogeneity in the electric field in the particle suspension of the cell.

Possible passivation layers are fluoropolymers which can be deposited by dipping the substrates 2,3 or SiO2 which can be sputtered or deposited by CVD etc.

The particle suspension comprises a plurality of anisometric, reflective particles (4) suspended in an insulating fluid. The suspension fluid may be butylacetate or a liquid organosiloxane polymer with a viscosity that permits Brownian motion of the particles but prevent sedimentation. Examples of suitable particles include metallic platelets of silver, aluminium or chromium, mica particles or particles of an inorganic titanium compound. The lengths of the particles are of the order 1 to 50 microns and they have a thickness of 5 to 300 nm. A typical cell has a cell gap of 200 microns between the passivation layers, a passivation layer in the range of 5-50 microns, an electrode width of 250 microns and an electrode gap of 50 microns. The middle layer 5 has a dielectric constant of 10 and each passivation layer 15 has a dielectric constant of 2. The right side of FIG. 6 also shows schematically how the suspended particles 4 are orientated in the cell. The particles 4 align perpendicular to the equipotential lines resulting in a light transmissive cell.

In FIG. 7 electrode 11a and 12a have a negative potential while electrode 11b and 12b have a positive potential. This results in an electric field parallel to the support members and equipotential lines largely perpendicular to the support members in the suspension medium 5. The gradient of the field lines and the directional inhomogeneities are to a large extent in the passivation layers. The particles are aligned with their long axis parallel to the support members resulting in a non-transmissive cell. It is further clear from FIG. 7 that the electric field extends over a portion of the electro-optical medium substantially corresponding to the width of two electrodes. Consequently, four electrodes are needed to switch between a transmissive and reflective state.

The configuration of positive and negative electrodes can be achieved by connecting the electrodes in a manner illustrated in FIG. 8. The top and bottom electrodes are connected to a source 16 providing a voltage V1. The cell is arranged such that top and bottom electrodes are connected to opposite terminals of the source 16. The top electrodes are connected to another source 17 providing a voltage V2 and the bottom electrodes are connected to a third source 18 providing a voltage V3. The cell is arranged such that the left and right hand electrodes of the cell are connected to opposite terminals of the source 17 and 18 respectively. The sources 16, 17 and 18 are further connected to switches 19, 20 and 21 respectively. The switched are further connected to a control unit 22. The control unit may be arranged to receive instructions on whether the switches should be on or off. In FIG. 8 switches 19, 20 and 21 are open such that no electric field is applied to the cell. The cell may be switched into a transmissive state as follows. The control unit receives instructions to close the all four switches 19, resulting in a voltage V1 being applied between the top 2 and bottom 3 support members resulting in the particles aligning themselves with their long axis perpendicular to the support members as shown in FIG. 6. On the other hand, to switch the cell into a non-transmissive state the control unit 22 would open switches 19 and close switches 20 and 21. Accordingly, a voltage V2 is applied between the left and right hand top electrodes 11b and 11c and a voltage V3 is applied between the left and right hand bottom electrodes 12b and 12c. When V2 and V3 are of the same magnitude an electric field parallel to the support members 2,3 is realised and the particles 4 align themselves with their long axis parallel to the support members as illustrated in FIG. 7.

The electrical field expands over an area corresponding to the size of two adjacent electrodes. If the subsequent set of a top and bottom electrode is addressed, the field is successively applied over the next cell volume. If all the electrodes in the row are addressed faster than the relaxation time of the particles, a uniform particle orientation will be realised across the whole row. Alternatively, the whole row can be driven simultaneously by connecting adjacent electrodes to opposite terminals of a voltage source as shown in FIG. 9. When V2 and V3 are equal in magnitude an electric field parallel to the support members 2 and 3 is realised and the row of electro-optical cells are in a reflective state. As in FIG. 8 a voltage V1 can be applied between the electrodes on the first and second support member, 2 and 3, causing a transmissive state. A control unit (not shown) is connected to the switches to control which switches need to be open and which need to be closed.

FIG. 10 shows part of a display containing a matrix of electro-optical cells that can be switched between transmissive and reflective mode. The display comprises a two dimensional array of cells constructed as described with reference to FIGS. 6 to 9. It comprises two layers of electrodes on the first and second support member, 2 and 3, with two passivation layers 14 and the particle suspension 5 between them. To switch a cell between a transmissive and a non-transmissive mode four electrodes are needed, two on each side of the suspended particle medium resulting in a cell 23 with the width equivalent to two adjacent electrodes and the height equivalent to one electrode. A light source may be provided behind the first support member 2 to provide light that can either be transmitted through the cells or reflected. In the reflective mode the screen may be lit from the front by ambient light.

The electric fields described in FIG. 6 to FIG. 10 result in the particle having more than one degree of freedom. The particles 24, 25 in FIG. 11, are both aligned with their long axis parallel to the electric field but particle 24 has its thin edge parallel to the support members whereas particle 25 has its large area parallel to the support members. By applying a second electric field perpendicular to the first, the degrees of freedom of the particle can be reduced and the orientation that satisfies both fields is selected.

FIG. 12a and 13a show an electro-optical cell 30 containing eight electrodes, four electrodes 11 on the first support member 2 and four electrodes 12 on the second support member 3. The electrode arrangement on the first support member 2 is identical to that of the second support member 3. The electrodes are connected in rows R1 and R2 and columns C1 and C2. Row R1 and row R2 on the first and second support member are connected to opposite terminals of voltage sources 16 and 17 respectively providing voltages V2 and V3. Column C1 and C2 on the first and second support member are connected to opposite terminals of voltage sources 26 and 27 respectively providing voltages V4 and V5. Furthermore, switches 19, 20, 28 and 29 separate the electrodes from each other and from the voltage sources 16, 17, 26 and 27 respectively. A control unit (not shown) can open and close switches 19, 20, 28 and 29. When switches 19 and 20 are closed a potential V2, V3 separates the left and right hands electrodes and an electric field as shown in FIG. 12 is applied. Consequently, the particles 24, 25 align with the long axis parallel to the electric field as shown in FIG. 12b. The particle has still one degree of freedom as shown by the orientation of particles 24 and 25. When switches 28 and 29 are closed and switches 19 and 20 are open a potential V4, V5 separates the rows on the first 2 and second 3 support members resulting in an electric field as shown in FIG. 13b. The particles 24, 25 align with their long axis parallel to the applied field but have still one degree of freedom as shown in FIG. 13b. The orientation of particle 24 is different in FIGS. 12 and 13, but the orientation of particle 25 is the same in FIGS. 12 and 13. Consequently, when the fields in FIG. 12 and FIG. 13 are applied intermittently the particles align according to the orientation that satisfies both fields, namely the one shown by particle 25. If the light enters the cell 1 from behind the first support member 2, the orientation of particle 25 will result in a highly reflective state since the large area of the particle is perpendicular to the beam of light. Alternatively, by means of AC fields of different frequencies the two perpendicular fields can be applied intermittently with short time intervals, such that the equilibrium state of each field is never reached and accordingly the particle adopts the orientation allowed by both fields. The use of a second electric field is of no consequence for the transmissive state. The first field is enough for switching the cell into a transmissive state and reducing the degree of freedom of the particles by introducing a second field perpendicular to the first field does not increase the level of transparency of the cell further.

FIG. 14 shows part of a display containing a matrix of the electro-optical cells described in FIG. 12 and FIG. 13. It comprises a layer of electrodes on each support members, 2 and 3, with two passivation layers 14 and the particle suspension 5 between them. The electro-optical cell described in FIG. 12 and 13 is shown in FIG. 14 with its corresponding particle suspension 30. The particle suspension corresponding to one complete cell has a height equivalent to the height of two electrodes on top of each other and a width equivalent to the width of two electrodes adjacent to each other as shown in FIGS. 12 and 13. A light source may be provided behind the first support member 2 to provide light that can either be transmitted through the cells or reflected.

A configuration of positive and negative electrodes for creating a deflecting cell is illustrated in FIG. 15. Electrodes 11a, 12a and 12b have a negative potential while electrodes 11b, 11c and 12c have a positive potential. This results in equipotential lines at an angle to the support members. The particles align perpendicular to the equipotential lines resulting in a cell that would partly deflect and partly transmit light. Three electrodes on each side of the particle suspension are used in this example to achieve a deflective cell. The electric fields shown in FIG. 15 can be achieved by connecting the electrodes as in FIG. 16. Electrode 11a is connected to the terminal of a source 17 having a second terminal connected to electrode 11b and 11c. Similarly electrodes 12a and 12b are connected to a terminal of a source 18 having a second terminal connected to electrode 12c. Furthermore, the electrodes on the first support and second support member are connected to opposite terminals of a source 16 providing a voltage V1. Switches 19, 20 and 21 are connected to source 16, 17 and 18 respectively. When switches 20 and 21 are open and switches 19 are closed, the cell is transmissive.

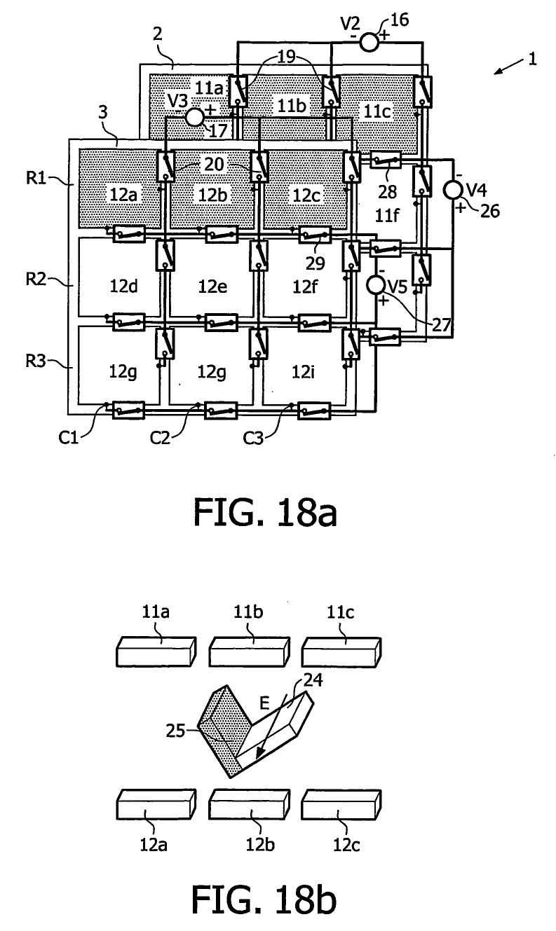

Only using one electric field means the particles have more than one degree of freedom. FIG. 17 shows a deflective cell 1 with an electric field that allows more than one degree of freedom. The cell contains a first support member 2 and a second support member 3, each having nine electrodes 11a to 11i and 12a to 12i. The first support member has further two sources 16 and 26 providing voltages. V2 and V4 respectively. Similarly the second support member has two sources 17 and 27 providing voltages V3 and V5 respectively. Furthermore, there are a number of switches in each column 19, 20 and each row, 28 and 29, connected to sources 16, 17, 26 and 27 respectively. The switches are connected to a control unit (not shown). When switches 19 and 20 are closed and switches 28 and 29 are open an electric field is applied at an angle from right hand corner of the first support member 2 to the left hand corner of the second support member 3 as shown in FIG. 17b. However, the particles still have one degree of freedom as shown by the orientation of particles 24 and 25. On the other hand when switches 19 and 20 are opened and switches 28 and 29 are closed an electric field is applied from the back of the support members to the front of the support members parallel to the support members, i.e. out of the plane of the paper in FIG. 18b. The particles 24, 25 align with their long axis parallel to the electric field but they still have one degree of freedom, which is clear when comparing the orientations of particle 24 and 25. However, if the fields in FIG. 17 and FIG. 18 are applied repeatedly, the particles will align to satisfy both fields; i.e. with the orientation of particle 25. Alternatively, by means of AC fields of different frequencies the two perpendicular fields can be applied intermittently with short time intervals, such that the equilibrium state of each field is never reached and accordingly the particle adopts the orientation allowed by both fields.

The electro-optical cell in FIGS. 17 and 18 can further be switched to a transmissive state by connecting the rear and front electrodes to opposite terminals of a source (not shown). Moreover a highly reflective state can be realised by connecting the electrodes in a manner suitable for obtaining two perpendicular electric fields parallel to the support members as described in FIG. 12. Consequently, an electro-optical cell containing nine electrodes on each side of the particle suspension can be switched between a transmissive state, a reflective state and a deflective state. A range of deflective angles can further be achieved by choosing an appropriate addressing asymmetry. For example electrodes 11c, 11f and 11i can be addressed to have a negative potential; thus, increasing the deflective angle. The addressing asymmetry of the electro-optical cell is not restricted to the examples of FIGS. 17 and 18. It should be clear to the skilled reader that maximum flexibility is achieved when each electrode can be switched individually allowing the deflective field to be tuned. Each electrode can be individually connected to a separate voltage source or an active matrix arrangement can be utilised to individually apply a potential to each the electrode.

The diagonal electric field expands over an area corresponding to the size of three electrodes. The field is stronger and more tilted in the centre of the unit cell and weaker and less tilted on the edge. Due to the slightly inhomogeneous field the particle orientation within a unit cell will vary. The particle orientation related to the strongest electrical field in the centre of the unit field can be achieved throughout the whole cell by stepping through the unit cell in three steps. In the first step, FIG. 19a the left electrodes, a, are asymmetrically addressed, creating a strong electric field between them. In the second step, FIG. 19b, the middle electrodes, b, of the unit cell are asymmetrically addressed so that the strongest electric field is realised between the middle electrodes. In the third step the right electrodes, c, are asymmetrically addressed so that the strongest electric field is realised between these electrodes. If this stepping occurs iteratively, the overall particle orientation in the whole cell will be dominated by the strongest diagonal field and the self-erasing effect of particle orientation by the weaker electrical field will be negligible.

In order to align the particles in the whole row of unit cells, the stepping can continue through the whole row. If the addressing sequence is faster than the thermal particle relaxation the diagonal particle orientation is realised over the whole cell. Alternatively, every third electrode can be connected to apply a diagonal field to the whole row simultaneously.

FIG. 20 shows an electro-optical cell not comprising a passivation layer. Comparing FIG. 6,7 and 15 with FIG. 20 it is clear that the field gradients in FIG. 20 are now expanding into the centre of the electro-optical cell resulting in an inhomogeneous field with equipotential lines 15 that are not parallel. The low dielectric constant of the passivation layer reduces the inhomogeneity in the electric field in the electro-optical cell.

It should be clear that the electrodes can be connected in many ways in order to achieve the electric fields described above and the connections are not restricted to the drawings. It should be noted that for some field directions, such as the field direction in the transmissive state, the driving electronics may only be connected to the first support members while the other support member only comprises electrodes connected to ground.

It should further be noted that according to the examples, the smallest unit cell switchable between a transmissive state and a highly reflective state needs 8 electrodes and the smallest unit cell switchable between a deflective state, a transmissive state and a highly reflective state needs 18 electrodes. However, it should be clear that more or fewer electrodes and voltage sources can be used to achieve the correct field strengths and particle orientation.

The geometry of the electrodes in the electro-optical cells above can be used in other applications than a suspended particle device. One example is the use of the electrode geometry in switchable colour filters based on cholesteric liquid crystals (CLC) as shown in FIG. 21 and FIG. 22. The molecules 32 in CLCs arrange themselves in layers 31 wherein the molecules 32 of each layer orient themselves along an axis known as the director 33. The director 33 is twisted in each layer with respect to the layer above and below and the orientation of each layer forms a helix with respect to the normal to the layers. The distance over which the director changes with 360 degrees is called the pitch (P). The reflected wavelength of the CLC is defined by a refractive index (n) and the Pitch (P) of the CLCs according to the relationship
λ=n*P(E)

When no electric field is applied to the liquid crystal, the crystal is in a reflective state (FIG. 22a). The colour of the reflected light can be tuned by applying an electric field parallel to the first and second support member. The electric field affects the director of each layer and elongates the pitch of the CLCs and accordingly changes the wavelength of the reflected light. A weak electric field is applied parallel to the first and second support members (2, 3) in FIG. 22b. Accordingly, the pitch in FIG. 22b is longer than the pitch in FIG. 22a and the reflected wavelength in FIG. 22b, λ₂, is longer than the reflected wavelength in FIG. 22a, λ₁. A very high electric field will completely unwind the helixes creating a transparent state as shown in FIG. 22c. Varying degrees of transparency can also be achieved by an applied field perpendicular to the support members. The higher the field, the more transparent the state. A weak electric field perpendicular to the support members (2, 3) creates a focal conic state (transparent state), as shown in FIG. 22d, which is stable even as the electric field is switched off. FIG. 22e shows the CLCs subject to a strong perpendicular electric field. The molecules align with the field and the cell is in a homeotropic and highly transmissive state. Consequently, by changing the magnitude and direction of the electric field in the electro-optical cell the reflected light exhibits various colours.

Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. An electro-optical cell (1) comprising:
first (2) and second (3) support members at least one of which is transparent to optical radiation (6) passing through the cell;
an electro-optical medium (5) between the support members; and
an electrode arrangement (11, 12) on both first and second support member to apply an electric field to the electro-optical medium (5), wherein the direction of the applied field can be changed from at least a first non-zero field distribution to at least a second non-zero field distribution, different from the first field distribution, by modifying the voltages of the electrodes, and wherein the direction of the first field distribution is other than opposite to that of the second field distribution.

2. An electro-optical cell (1) according to claim 1 wherein the electrodes (11, 12) are configured such that the first field distribution is generally perpendicular to the support members (2, 3) and the second field distribution is generally aligned with the support members (2,3).

3. An electro-optical cell (1) according to claim 1 wherein the electrodes are configured to realise at least two electric field distributions wherein one of them is generally perpendicular to the support members (2, 3) and the other one is generally at an oblique angle (7) with respect to the support members (2, 3).

4. An electro-optical cell (1) according to claim 1 wherein the electrodes are configured to realise at least two electric field distributions wherein one of them is generally aligned with the support members (2, 3) and the other one is generally at an oblique angle (7) with respect to the support members (2, 3).

5. An electro-optical cell (1) of claim 1 wherein the electrode arrangement (11, 12) includes a pair of electrodes (11a, 12a) comprising a first electrode (11a) on the first support member (2) and a second electrode (12a) on the second support member (3) and the first and second electrodes can be addressed such that the first field distribution is applied between the first and the second electrodes.

6. An electro-optical cell (1) of claim 5 wherein the electrodes of the first pair (11a, 12a) are arranged such that the first field distribution in the electro-optical medium in use is substantially perpendicular with respect to the support members (2,3).

7. An electro-optical cell (1) of claim 5 wherein a second pair of electrodes (11b, 12b) is arranged adjacent to the first pair of electrodes on the first and second support members.

8. An electro-optical cell (1) of claim 7 wherein the electrodes of the first and second pairs (11a, 12a, 11b, 12b) can be addressed to apply the second field distribution.

9. An electro-optical cell (1) of claim 7 wherein the first and second pairs of electrodes (11a, 12a, 11a, 12b) are arranged such that the second field distribution in the electro-optical medium in use is aligned with the support members (2, 3).

10. An electro-optical cell (1) of claim 1 wherein the electro-optical medium (5) comprises cholesteric liquid crystals.

11. An electro-optical cell (1) of claim 1 wherein the electro-optical medium (5) comprises anisometric, suspended particles (4).

12. An electro-optical cell (1) in claim 11 wherein the arrangement of at least the first pair of electrodes is operable to align the particles (4) in dependence on the first field distribution perpendicular to the support members (2, 3) such that the cell can be switched to a transmissive mode.

13. An electro-optical cell (1) of claim 11 wherein the arrangement of the first and second pairs of electrodes (11a, 12a, 11a, 12b) are operable to align the particles (4) in dependence on the second field distribution aligned with the support members (2, 3) such that the cell can be switched into a non-transmissive mode.

14. An electro-optical cell (1) of claim 13 wherein the electro-optical medium (5) comprises reflecting particles such that the non-transmissive mode is also a reflective mode.

15. An electro-optical cell (1) of claim 11 wherein a third pair of electrodes (11c, 12c) is arranged adjacent and in line with the first and second pair of electrodes (11a, 12a, 11b, 12b) on the first and second support members (2, 3).

16. An electro-optical cell (1) of claim 15 wherein the electrodes of the first, second and third pair of electrodes (11a-11c, 12a-12c) can be addressed to apply a third field distribution.

17. An electro-optical cell (1) of claim 16 wherein the electrodes of the first, second and third pair (11a-11c, 12a-12c) of electrodes are arranged such that the third field distribution in the electro-optical medium (5) in use is at an oblique angle (7) to the support members (2, 3).

18. An electro-optical cell (1) of claim 17 wherein the oblique angle (7) of the third field distribution can be tuned by addressing the electrodes of the first, second and third pair (11a-11c, 12a-12c) of electrodes appropriately.

19. An electro-optical cell of claim 17 wherein the electrode arrangement on the first, second and third pair of electrodes (11a-11c, 12a-12c) is operable to align the anisometric, reflecting particles (4) in dependence on the third field distribution at an oblique angle (7) to the support members (2, 3) such that the cell can be switched into a partly deflective state.

20. An electro-optical cell (1) of claim 19 wherein the electrode arrangement of the first, second and third pairs of electrodes (11a-11c, 12a-12c) is such that the cell can be switched from a first field distribution corresponding to a transmissive state to a second field distribution corresponding to a reflective state to a third field distribution corresponding to a deflective state.

21. An electro-optical cell (1) of claim 11 wherein the first and second pair of electrodes (11a, 12a, 11b, 12b) are arranged in a first row (R1) of electrodes and the cell comprises a second row (R2) of electrodes such that a matrix of four electrodes (11a, 12a, 11b, 12b) are formed on each of the support members.

22. An electro-optical cell (1) of claim 21 wherein the electrodes (11, 12) can be addressed to form two perpendicular field distributions and the electrodes are arranged such that a particle (25) in the electro-optical medium subject to the two perpendicular field distributions can only have one degree of freedom.

23. An electro-optical cell (1) of claim 22 wherein the particle (25) can be orientated subject to the two perpendicular field distributions perpendicular to or aligned with the support members (2, 3) such that the cell can be switched to a transmissive or highly reflective state by changing at least one of the two perpendicular field distributions.

24. An electro-optical cell (1) of claim 22 wherein the two perpendicular electric field distributions are applied simultaneously or repeatedly.

25. An electro-optical cell (1) of claim 15 wherein the first, second and third pair of electrodes (11a-11c, 12a-12c) form a third row of electrodes (R1) and the cell comprise a fourth (R2) and a fifth (R3) row forming a matrix of nine electrodes (11a-11i, 12a-12i) on each of the support members (2, 3).

26. An electro-optical cell (1) of claim 25 wherein the electrodes (11, 12) can be addressed to form two perpendicular field distributions and the electrodes are arranged such that a particle (25) in the electro-optical medium (5) subject to the two perpendicular field distributions can only have one degree of freedom.

27. An electro-optical cell (1) of claim 26 wherein the particle (25) can be subject to the two perpendicular field distributions perpendicular to, aligned with or at an oblique angle (7) to the support members (2,3) such that the cell can be switched to a transmissive, highly reflective or deflecting state by changing at least one of the two perpendicular field distributions.

28. An electro-optical cell (1) of claim 26 wherein the two perpendicular electric field distributions are applied simultaneously or repeatedly.

29. An electro-optical cell (1) according to claim 11 further comprising driving electronics to change the charge of the electrodes (11, 12) on the first and second support member (2, 3) in order to switch the orientation of the suspended particles (4).

30. An electro-optical cell (1) of claim 1 further comprising more than one layer (5, 14) of dielectric material between the support members (2, 3),
where said layers consist of materials of varying dielectric constants in order to reduce the inhomogeneities in the electric field produced in the electro-optical medium (5).

31. An electro-optical (1) cell according to claim 1 wherein the electrode arrangement is disposed solely on the support members (2, 3).

32. An electro-optical cell (1) according to claim 1 wherein the support members (2, 3) comprise generally parallel plates.

33. An electro-optical cell (1) comprising:
first (2) and second (3) support members at least one of which is transparent to optical radiation (6) passing through the cell;
an electro-optical medium (5) between the support members; and
more than one electrode (11, 12) on each of the first and second support member to apply an electric field to the electro-optical medium (5), wherein the direction of the applied field can be changed from at least a first non-zero field distribution to at least a second non-zero field distribution, different from the first field distribution, by modifying the voltages of the electrodes.

34. An apparatus comprising: first and second support members (2, 3);
a medium (5) between the support members comprising suspended particles (24, 25); and
an electrode arrangement on both first and second support member to apply a first and second electric field distribution to the medium, wherein the direction of the first and second field distribution in use are perpendicular causing the suspended particles subject to the first and second field distribution to only have one degree of freedom.
